(19) United States
(12) Patent Application Publication
(10) Pub. No.: US 2007/0112537 A1
(43) Pub. Date: May 17, 2007

(54) Method for learning characteristic curves for hydraulic valves

(75) Inventors: Ralph Gronau, Wetter (DE); Dieter Burkhard, Bingen-Budesheim (DE); Mirco Loos, Elversberg (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/556,540

(22) PCT Filed: May 13, 2004
(86) PCT No.: PCT/EP04/50801

§ 371 Date: Nov. 20, 2006

(30) Foreign Application Priority Data
May 14, 2003 (DE) 10321783.5

(51) Int. Cl. G01L 25/00

(52) U.S. Cl. 702/105

(57) ABSTRACT

The described method and computer program product for calibrating one or more electrically actuated hydraulic valves of analog operation render it possible to facilitate the provision of precise actuation characteristic curves in a controlled motor vehicle brake system. To achieve this aim, at least one or respectively one characteristic curve is initially predetermined during the operation of a brake device, and the predetermined actuation characteristic curve is corrected using a learning method during driving of the vehicle.

### BACKGROUND OF THE INVENTION

The present invention relates to a method for learning actuation characteristic curves for hydraulic valves.

In electronically controllable motor vehicle brakes with anti-lock functions (ABS) among others, there is a constantly rising demand in enhanced quality of the control, with the aim of enhancing the control comfort in addition to an improved safety. However, this target mostly requires complicated and, hence, costly hydraulic systems which must be equipped with additional components (pressure sensors, control valves, switching orifices, etc.).

EP 0 876 270 A1 (P 8598) discloses the basic principle of a control cycle in an anti-lock control. According to the method described therein, the gradient of the brake pressure increase in the previous brake pressure increase phase is taken into consideration for the control of the brake pressure increase during a control operation in the current brake pressure increase phase.

It is furthermore known in the art to arrange for a mechanical change-over of gradients (switching orifices) for the provision of different pressure gradients in order to enhance the comfort, which entails disadvantages in terms of costs, however.

Compared to switching orifices, electrically actuatable hydraulic valve of analog operation imply an improvement as they can be employed in a more flexible fashion. To provide a hydraulic valve allowing analog use, attempts have frequently been made to define the magnetic field of the valve coil and, hence, the tappet position for producing a desired pressure gradient by way of the coil current in a manner as precisely as possible. Among others, the tappet position depends rather sensitively on the current pressure conditions and valve-related manufacturing tolerances. An object of the invention is to improve the precision in the actuation of analog operable valves so that the desired pressure gradient can be adjusted reproducibly by way of a fixed coil current. In addition to the inaccuracies caused by manufacturing tolerances, there is the problem that the analog actuation also requires a sufficiently high rate of precision of the differential pressure control in case there is no direct feedback from a pressure sensor arranged in the area of the valve for cost reasons. To eliminate the above-mentioned differences between valve current and tappet position which are caused by tolerances related to manufacturing technology, complicated measurements of the individual valve characteristics are usually necessary for calibration of the valves after the manufacture of the valves in the assembled brake system. In this case, however, it would be necessary to connect each manufactured brake control assembly to a test bench, what would have an undesirably great influence on manufacturing costs.

### SUMMARY OF THE INVENTION

The problems presented hereinabove are solved according to the invention using a calibration method which, during the operation of a brake device, in particular an anti-lock control, initially predetermines at least one or respectively one actuation characteristic curve, and then corrects the predetermined actuation characteristic curve in a learning method, wherein a new actuation characteristic curve is determined in particular for the correction, or correction variables are determined for the correction of the existing actuation characteristic curve.

According to the method of the invention, initially an actuation characteristic curve is predetermined during the operation of a brake device, i.e. during driving of the vehicle, for example. This predetermined actuation characteristic curve is e.g. either stored at the factory site or is independently drafted one time by an additional calibration routine during the initiation of the brake control device. The prevailing actuation characteristic curve is then newly calculated or corrected during electronic brake control operations (e.g. during an ABS or ESP control operation). For correction purposes a learning method is performed wherein either the actuation characteristic curve is newly calculated or, what is preferred, correction values are produced by means of which the predetermined actuation characteristic curve is corrected.

In the preferred application of the method of the invention in a per se known anti-lock control, which may also be extended, e.g. by additional controls such as TCS, YTC, ESP, EBV (EBV=electronic brake force distribution), in the event of a spinning wheel, initially pressure is reduced in a known fashion in at least one wheel cylinder by means of a corresponding hydraulic valve. Following this phase of pressure reduction is a so-called phase of pressure increase during ABS control, in which phase several pressure increase pulses of an appropriate number and duration are produced. This process is repeated several times (control cycles).

A direct determination of the current individual wheel cylinder pressure p_{z} and the wheel cylinder pressure p_{z}ⁱ at which the wheel concerned becomes unstable (locking pressure level), cannot be carried out in devices without wheel-individual pressure sensors. Methods for determining these quantities in systems with digital valves are per se known in the art and described in detail in patent applications EP 0 876 270 A1 (P 8598) and DE 197 37 779 A. In these methods, learning methods for the calculation of the pressure increase times are performed, with an average pressure increase gradient resulting from the sequence of the pressure increase pulses.

In the present case, an invariable pressure increase gradient is predetermined at least in the respective driving situation, what is in contrast to prior art brake devices. The current which allows opening the valve that is to be respectively actuated at a defined pressure increase gradient is a variable quantity which shall be determined among others. It is then possible to adjust a gradient at the valve based on the opening current by way of a factor. The pressure increase time can be essentially predetermined at an invariable rate in this case.

The total pressure difference of the corresponding control cycle is essentially achieved from the sum of the pressure increases respectively caused during individual actuation intervals during the individual pulses necessary for pressure increase. The corresponding pressure increase times or pressure requirements of the individual intervals of this pressure increase phase result in the sum for each control cycle of a total pressure increase time T_{actual} corresponding to a total pressure increase P which can be measured for each pressure increase phase individually for each wheel in the control device in which the ABS algorithm is processed.

It is preferred that the learning method extends over several cycles of the anti-lock control (learning cycle). In each cycle or in each suitable cycle, a correction of the predetermined characteristic curve is performed according to a recursive formula by means of the parameters found in the present cycle.

According to the method of the invention, preferably the actuation characteristic curve for the hydraulic valve G=f (I, Δp) or I=f′ (Δp, G) is determined directly or indirectly for each individual valve, and I represents the current through the magnet coil used to actuate the valve, G represents the pressure gradient produced by the valve, and Δp represents the pressure difference prevailing at the valve when the valve is just in a still closed condition. As the pressure difference changes when the valve is open, the value determined based on the functions f or f′ is only an approximate value.

In a preferred embodiment, a fixed, e.g. experimentally determined, pressure increase gradient of e.g. approximately 300 bar/s is predetermined during anti-lock control at least in the presently prevailing driving situation (can be dependent on the coefficient of friction) or also in all driving situations. The specification of the pressure increase gradient is given by adjusting a defined, invariable valve current. With this pressure increase gradient, the control is then executed in order to implement the learning method of the invention. The method described herein will then determine the individual valve current which is optimal for this predetermined pressure increase gradient by means of the existing calibrated characteristic curve or the learned correction variables.

As has been mentioned hereinabove, it can be arranged for in a particularly preferred manner that the predetermined pressure increase gradient is adapted to the coefficient-of-friction conditions of the roadway in dependence on the detected driving situation. However, as this occurs, the predetermined and, hence, invariable pressure increase gradient and, thus, the valve current stays constant at least until completion of the instantaneous control operation.

According to the method, the correction variable k is preferably produced according to the formula
kₙ=1−(1−K_{Fil,n-1})*√(T_{actual,n}/T_{nominal,n})

wherein
k_{Fil,n-1}=((K_{Fil,n-2}*(n−2))+kₙ)/(n−1),

n is the number of the learned values k,

T_{actual,n} is the summed-up increase time of the currently performed pressure increase and

T_{nominal,n} is the nominal pressure increase time calculated from the desired pressure difference and the nominal gradient. The pressure difference from the previous pressure reduction is determined therein.

It is preferred that a quantity Q is included in the determination of the correction variable, said quantity Q being the quotient between the pressure reduction difference ΔP_{reduction} of the previous pressure reduction and the pressure increase difference ΔP_{increase} of the currently increased pressure:

$$Q = \frac{{AP}_{increase}}{{AP}_{reduction}}$$

The quantity Q is preferably multiplied by the correction variable k:
kₙ=kₙ₋₁*Q.

A correction of the characteristic curve which is typically in the range of some percents is achieved this way.

Another alternatively preferred possibility of determining the correction variable k resides in that an absolute correction is performed according to the formula
kₙ=kₙ₋₁+Q*i.

The parameter i in this case indicates an amplification factor which is weighted depending on the quantity Q. In the last mentioned case, there is no need to calculate the quantity k_{Fil,n-1}.

It is preferred that the correction factor k is calculated only if the previous control cycle makes a correction necessary. A correction is e.g. required when the number of the increase pulses does not meet the expectations.

Advantageously, the learning method is performed individually for each wheel. The learned values are suitably stored either beyond the ignition cycle, or they are newly calculated for each control operation. The counter n which stores the number of the considered control cycles can be reset (Reset) to an initial value depending on or independently of the current ignition cycle. Suitably, the parameter n is reset at the commencement of each ignition cycle. The desired accuracy of the actuation characteristic curves can be achieved this way in a shorter time.

The learning method can preferably be considered as completed when the current value of kᵢ of a cycle has changed by only less than 5% still in comparison to the learned value.

The total pressure increase time Tₙₒₘᵢₙₐₗ can be distributed among several pulses in a largely optional manner, and the optimal value for the number of the pulses depends on the electrical and hydraulic properties of the brake system. A preferred range for this pulse number lies between 3 and 4 pulses approximately. In a particularly preferred embodiment of the invention, a reduction in current corresponding to the pressure difference to be assumed is performed after completion of the learning method in order to improve the control. This results in a specification of the pressure increase gradient G in dependence on I and Δp.

According to another preferred embodiment of the invention, the invariably predetermined actuation characteristic curve, which is corrected using the method described hereinabove, is determined itself in an additional process by means of the electronic control device, for example, upon the first initiation. During the second, additional calibration process, an opening current characteristic curve I=G(Δp) is fixed in particular which, along with the correction factors determined hereinabove, leads to a corrected actuation characteristic curve according to the invention.

The invention will be explained in detail hereinbelow by way of the embodiment in FIG. 1.

### BRIEF DESCRIPTION OF THE DRAWING

FIG. 1 shows the actuation characteristic curve G 1 for an electrically actuatable hydraulic valve in a graphic chart

### DETAILED DESCRIPTION OF THE DRAWING

The X-axis refers to the pressure difference at the valve, with the valve still closed. The valve coil current needed to adjust a defined pressure difference is plotted in the Y-direction. Curve 1 corresponds to the opening current Iₒₚₑₙ to be generated, with the valve being about to open. This curve concerns the actuation curve to be calibrated which, as a starting point, is made the basis for the learning method. It is appropriate to define a medium course for curve 1 which is suitable for all valves of a line of products and to store this curve permanently in a memory of the controller of the device. Points 2 represent measured values of a valve in the brake device under review. Points 4 represent measured values of another valve of the same series which, due to manufacturing tolerances, has a behavior in terms of the opening-current/pressure curve that differs from the valve under review.

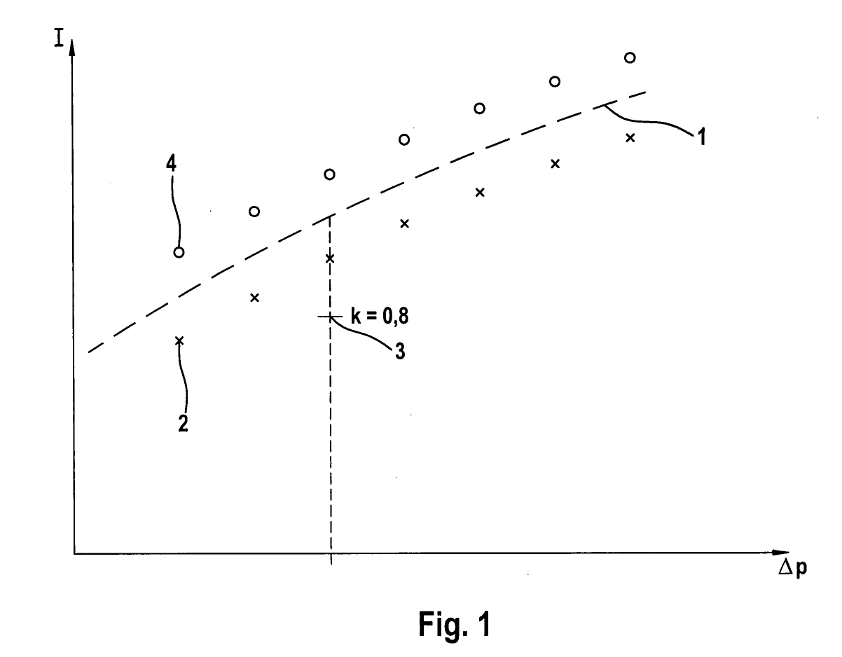

Initially, a ‘fixed’ pressure increase gradient G_{fixed} of 300 bar per second is predetermined. As has been stated already, curves Iₒₚₑₙ=G(Δp) have been stored individually for each valve in a memory in the electronic controller of the brake device, the said curves indicating the current at which the related valve is just about to open. The initially memorized value I_{Open} does not yet completely take into account the tolerances of the valve which are due to reasons of manufacture so that this curve has to be corrected by the method of the example. To this end, first of all a nominal pressure increase time is determined from the pressure difference Δp predetermined by ABS according to the formula Tₙₒₘᵢₙₐₗ=Δp/G_{fixed}. A value of 0.8 is predetermined as an initial value for the correction factor k₁. For the first control cycle, a nominal current of Iₙₒₘᵢₙₐₗ=Iₒₚₑₙ*k₁ (point 3 in FIG. 1) results therefrom. The respectively present value for the correction variable k is produced according to the following formula:
kₙ=1−(1−K_{Fil,n-1})*√(T_{actual,n}/T_{nominal,n}).

In this arrangement,
k_{Fil,n-1}=((K_{Fil,n-2}*(n−2))+kₙ)/(n−1).

wherein n is the number of the learned values k,

T_{actual} is the summed-up increase time of the currently performed pressure increase and

Tₙₒₘᵢₙₐₗ is the nominal pressure increase time calculated from the desired pressure difference (determined from the previous pressure reduction) and the nominal gradient.

This shows that the difference between the predetermined pressure increase gradient and the actual pressure increase gradient can be taken into account for the recursive optimization of the actuation characteristic curve of a hydraulic valve.

1. Method for the calibration of one or more electrically actuated hydraulic valves of analog operation,
characterized in that during the operation of a brake device, in particular an anti-lock control, initially at least one or respectively one actuation characteristic curve is predetermined, and the predetermined actuation characteristic curve is then corrected in a learning method, wherein a new actuation characteristic curve is determined in particular for the correction, or correction variables are determined for the correction of the existing actuation characteristic curve.

2. Method as claimed in claim 1,
characterized in that the learning method extends over several cycles of the anti-lock control with the number n, and in each cycle or in each suitable cycle, a correction of the predetermined characteristic curve is performed learning cycle) according to a recursive formula by means of the parameters found in the present cycle.

3. Method as claimed in claim 1 or 2,
characterized in that for correction purposes, the pressure increase times required during wheel control or pressure requirements are collected, and a corrected characteristic curve is or correction variables are calculated respectively on the basis of the prevailing collected pressure increase times or pressure requirements.

4. Method as claimed in at least one of the preceding claims,
characterized in that the learning method is used to produce a correction variable, in particular a correction factor k, for a valve, said correction variable/factor being connected to/multiplied by a predetermined actuation characteristic curve of the valve in order to produce a corrected actuation characteristic curve.

5. Method as claimed in at least one of the preceding claims,
characterized in that the predetermined actuation curve is stored to be fixed (e.g. ROM) at the factory site or to be deletable (e.g. RAM, EEPROM, etc.) in the basic brake device prior to the first learning cycle, or is determined according to a second, additional calibration process.

6. Method as claimed in claim 4 or 5,
characterized in that the correction variable k is preferably produced according to the formula
kₙ1−(1−K_{Fil,n-1})*√(T_{actual,n}/T_{nominal,n})
wherein
k_{Fil,n-1}=((K_{Fil,n-2}*(n−2))+kₙ)/(n−1),
n is the number of the learned values k,
T_{actual,n} is the summed-up increase time/pressure requirement of the currently performed pressure increase and
T_{nominal,n} is the nominal pressure increase time calculated from the desired pressure difference and the nominal gradient, and the pressure difference is determined from the previous pressure reduction.

7. Method as claimed in at least one of the preceding claims,
characterized in that during the learning method, a value which is considered as optimal for the brake device is predetermined for the pressure increase gradient, which value is at least not modified in the current control until completion of the control by means of the determined correction variables or the determined corrected actuation characteristic curve.

8. Method as claimed in at least one of the preceding claims,
characterized in that the predetermined pressure increase gradient of the anti-lock control is adjusted differently for defined driving situations by using the determined correction variables or the determined corrected actuation characteristic curve, and the learning method for newly predetermined gradients is performed especially for the newly predetermined gradient.

9. Computer program product,
characterized in that said product along with an arithmetic unit is suitable for implementing a method as claimed in at least one of claims 1 to 8.
